(19) United States
(12) Patent Application Publication
(10) Pub. No.: US 2008/0086395 A1
(43) Pub. Date: Apr. 10, 2008

(54) METHOD AND APPARATUS FOR FREQUENCY INDEPENDENT PROCESSOR UTILIZATION RECORDING REGISTER IN A SIMULTANEOUSLY MULTI-THREADED PROCESSOR

(76) Inventors: LARRY B. BRENNER, Austin, TX (US); Michael S. Floyd, Austin, TX (US); Christopher Francois, Shakopee, MN (US); Naresh Nayar, Rochester, MN (US); Freeman L. Rawson, Austin, TX (US); Randal C. Swanberg, Round Rock, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/539,225

(22) Filed: Oct. 6, 2006

(51) Int. Cl. G07F 19/00

(52) U.S. Cl. 705/34

(57) ABSTRACT

The present invention thus provides for a method, system, and computer-usable medium that afford an equitably charging of a customer for computer usage time. In a preferred embodiment, the method includes the steps of: tracking an amount of computer resources in a Simultaneous Multithreading (SMT) computer that are available to a customer for a specified period of time; determining if the computer resources in the SMT computer are operating at a nominal rate; and in response to determining that the computer resources are operating at a non-nominal rate, adjusting a billing charge to the customer, wherein the billing charge reflects that the customer has available computer resources, in the SMT computer, that are not operating at the nominal rate during the specified period of time.

### CROSS REFERENCE TO RELATED APPLICATIONS

The present application is related to U.S. patent application Ser. No. 10/422,025 (U.S. Patent Application Publication No. US 2004/0216113 A1), titled “Accounting Method and Logic for Determining Per-Thread Processor Resource Utilization in a Simultaneous Multi-Threaded (SMT) Processor,” and filed on Apr. 23, 2003. The above-mentioned patent application is assigned to the assignee of the present invention and is incorporated herein by reference in its entirety.

### BACKGROUND OF THE INVENTION

1. Technical Field

The present invention relates in general to the field of computers and other data processing systems, including hardware, software and processes. More particularly, the present invention pertains to tracking and equitably billing computer usage time.

2. Description of the Related Art

While many enterprises own and maintain their own computing equipment, some lease time on a non-owned computer. That is, rather than own and operate a large-frame computer such as a server, or a high-performance computer such as a supercomputer, an enterprise will simply lease a third-party's computer for the amount of time that computing power is needed. Such leases typically are charged for real-time usage (also known as “wall clock time.”) That is, the lessee is charged for the amount of real time (seconds, minutes, hours) that they are actually using the computer. If the lessee were leasing time on a dedicated machine, billing is simple and fair. However, if the lessee is leasing computer time on a multi-thread machine that is handling multiple-lessee's work, then the billing quickly becomes inequitable. That is, if the leased computer is processing multiple threads for multiple customers (lessees), then overall computer performance is likely to drop, especially on systems that use aggressive power management. This drop in performance is often caused by an overtaxing of the computer's processing resources (e.g., execution units). When overtaxed, the power management subsystem of the computer will protect the machine by slowing down throughput, both by throttling down the number of executions handled per time unit, as well as by slowing down clock cycle frequencies. This leads to a lessee having to lease more computer time, since jobs run slower on a throttled-down system.

Furthermore, the operating systems available on some server-class computing hardware such as IBM's System P and System I offer exact processor accounting based on the ticks of the timebase (e.g., “wall clock” time) register. This feature allows customers to charge accurately for the CPU time used, a feature widely used by customers running data centers and computing utilities. With the introduction of simultaneous multithreading (SMT), simple use of the timekeeping hardware in the processor is no longer sufficient because the SMT mechanism allocates processing resources to competing hardware threads on a very fine-grained basis, for example, at each instruction dispatch cycle in the processor. As long as each processor cycle has the same computational value and each time unit counted by the mechanism represents the same number of processing cycles, a per-thread counter recording equally sized time units is sufficient. However, when different processor cycles have different computational values and when the same number of counted time units represent different amounts of available computational power, this is no longer sufficient.

### SUMMARY OF THE INVENTION

To address the problem of adjusting billing rates for a computer system whose throughput has been changed (either decreased or increased), the present invention provides an improved computer-implementable method, system and computer-usable medium for accurately charging for actual available computing resources in a computer whose underlying performance has been altered, for example, by a power management subsystem. In a preferred embodiment, the method includes the steps of: tracking an amount of computer resources in a Simultaneous Multithreading (SMT) computer that are available to a customer for a specified period of time; determining if the computer resources in the SMT computer are operating at a nominal rate; and in response to determining that the computer resources are operating at a non-nominal rate, adjusting a billing charge to the customer, wherein the billing charge reflects that the customer has available computer resources, in the SMT computer, that are not operating at the nominal rate during the specified period of time.

Thus, if the computer is operating at a rate below nominal, the charge to the customer will be proportionally decreased, and likewise if the computer is operating at a rate above nominal, the charge will be proportionally increased. In general, a static or fixed computer “job” or task will cost the customer close to the same amount of charge every time it is run. If the computer is running at half the nominal operating rate it will likely take twice as much time to complete the job. However, the customer will not be charged double the amount when double the work was not provided.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a high-level flow-chart of exemplary steps taken to adjust how much a computer lessee is charged according to how fast a leased computer is operating;

FIG. 2A illustrates an exemplary leased computer in which the present invention may be implemented;

FIG. 2B depicts additional detail of performance throttles found in an exemplary processor in the computer illustrated in FIG. 2A; and

FIGS. 3A-B illustrate additional detail of a processor core of the processor depicted in FIG. 2B.

### DETAILED DESCRIPTION OF THE PREFERRED EMBODIMENT

The present invention is directed to accounting for processing resources when an active power and thermal manager takes actions that speed up or slow down the processors in the system. For the purposes of the presently disclosed invention, the preferred embodiment is described in terms of an implementation in the IBM PowerPC architecture and the IBM System P and System I computing systems. The systems software includes the hypervisor and one or more of the supported operating systems, including AIX, Linux and i5OS. The preferred embodiment of the present invention provides an active power and thermal management facility that controls the operation of the computer real-time, via an out-of-band external microcontroller. Note, however, that other embodiments and implementations are within the scope of the present invention.

The invention disclosed herein provides a way of tracking the processor resource, in terms of time, consumed by a particular program in a manner that is unaffected by the current throughput and speed setting of the processor, both of which may be varied by the computer's power and thermal management facility. The mechanism builds on a previously existing mechanism (described in U.S. patent application Ser. No. 10/422,025, titled “Accounting Method and Logic for Determining Per-Thread Processor Resource Utilization in a Simultaneous Multi-Threaded (SMT) Processor”) that is used to account for processor time on processor that implements simultaneous multithreading (SMT). That mechanism, which continues to be useful and is retained for compatibility, is affected by the changes in processing speed. The presently disclosed invention offers the advantage of a precise way to track the use of CPU time that can be managed by systems software with low overhead using registers available in the processor.

A Scaled Processor Utilization of Resources Register (SPURR), disclosed herein, is a new facility that allows a computing system such as an IBM System P or System I computer to track precisely the computing resource allocated to a thread even though the processors change their processing speeds and capacities as a result of power and thermal management actions.

### Power and Thermal Management

Many new generation computing systems require active power and thermal management in order to function correctly, maintain their stability, reduce operating costs and extract maximum performance. One of the major consumers of power and sources of heat in the computing system is the processor, and many of the available power management techniques alter processing operating characteristics of the processors in the system to control power and temperature. A representative set of management techniques for reducing processor power include: voltage and frequency scaling (also known as slewing); pipeline throttling; and instructions per cycle (IPC) throttling (also known as IPC clipping or limiting). Voltage and frequency slewing is done together since reducing the voltage has a more dramatic impact on power than slewing frequency alone, but only the frequency slewing actually affects the processor speed and is visible to the software.

These techniques all save power, but they also change the apparent speed of the processor away from its nominal value. The result is that the speeds of the processors change over time and are not necessarily the nominal value associated with the system. In turn, this implies that not all milliseconds of CPU time have the same computational value. Some can perform more computation than others, and this effect is visible to code executing on the system.

### System Time Keeping

For the purposes of exposition in the presently disclosed invention, the system timekeeping function is described in terms taken from the PowerPC architecture. However, other processor architectures have similar features for keeping time. In the case of past PowerPC systems, the timebase register kept time in terms of ticks, which were some multiple of the processor frequency. In more modern PowerPC systems, the timebase continues to tick at a constant rate controlled by an invariant external time reference input to allow the system to track wall-clock time correctly. Thus, regardless of whether the frequency of the processor is being varied, the timebase increments at the same rate, and each timebase tick represents the same amount of wall-clock time.

### Processor Utilization of Resources Register (PURR)

The architecture of the IBM PowerPC includes a per-hardware-thread special-purpose register (SPR) for tracking the processor time allocated to each hardware thread in an SMT processor. In the case of the PowerPC, this register is called the PURR, the Processor Utilization of Resources Register. There is one PURR for each hardware thread that contains data specific to that particular thread. The PURR is defined to be 64 bits long. It is writeable in privileged state with the hypervisor bit on (HV=1), readable in privileged state and inaccessible in problem state. This definition allows a hypervisor to virtualize the PURR for the operating systems by saving and restoring it on context switch, and this is, in fact, what the standard hypervisor does. In systems with active power management, the definition of the PURR is the same as it was for previous generations of processors. In the following, HWT is a hardware thread and tb is the value of the TimeBase register in TimeBase ticks. For machines that can only dispatch from a single hardware thread on a given processor cycle, the definition of the PURR is given by (PURRDO).

(PURRDO)PURR(HWT)=(cycles_assigned_to_{—}HWT_per_{—}tb_tick/available_cycles_per_{—}tb_tick)*(tb)

However, some processor designs can dispatch instructions from multiple hardware threads in a single cycle. In this case, a better definition of the PURR is given by (PURRD).

(PURRD)PURR(HWT_{—}i)=(HWT_iinstructions_dispatched_per_{—}tb_tick/(ΣHWT_{—}j_instructions_dispatched_per_{—}tb_tick))*tb

The sum in the denominator is taken over all of the hardware threads of the processor.

The PURR is subject to certain invariants that systems implementing this invention maintain.

(PURRI1) For any HWT, PURR(HWT) is monotonically non-decreasing.

(PURRI2) For a processor core running in single-threaded mode in a dedicated-processor partition, PURR=tb.

(PURRI3) For a processor core running with SMT enabled in dedicated-processor partition, Σ PURR(HWT)=tb, where the sum is taken over all of the hardware threads for the core.

(PURRI4) For a core running single-threaded in a shared-processor partition, PURR=<TimeBase ticks that the virtual processor was dispatched>.

(PURRI5) For an SMT-enabled core in a shared-processor partition, Σ PURR(HWT)=<TimeBase ticks the virtual processor was dispatched>.

On systems implementing this invention, the TimeBase ticks at constant frequency, independent of processor frequency, so that Σ PURR(HWT) also has a constant frequency that is not dependent on the state of the power and thermal management mechanisms. The number of processor cycles per TimeBase tick changes based on the current frequency, which frequency slewing changes. Throttling divides the available cycles into windows with a fixed number of run or live cycles followed by another fixed number of hold or dead cycles. In addition, the processor core can throttle by limiting the instructions per cycle (IPC) rate that it achieves to stay below a particular value. IPC-limiting suppresses dispatch on the current cycle if it could cause the thread to exceed the processor core's IPC limit. It is worth noting that all of the power and thermal actions are per processor core and affect all of the threads on the core in the same manner.

Given these features, the PURR is used in the following situations:

(PURRU1) The PURR exists to maintain compatibility with previous systems and for unchanged system software.

(PURRU2) The PURR allows the system software to calculate the utilization of the processor relative to the environment in which it runs. These utilization values are useful for capacity planning since they allow one to determine how much of the available processor resource is being used. Here the available processor resource varies depending on environmental conditions and power and thermal management actions.

(PURRU3) The PURR-based utilization values support the calculation of logical and physical processor utilizations as defined by some current operating system implementations.

### Scaled Processor Utilization of Resources Register (SPURR)

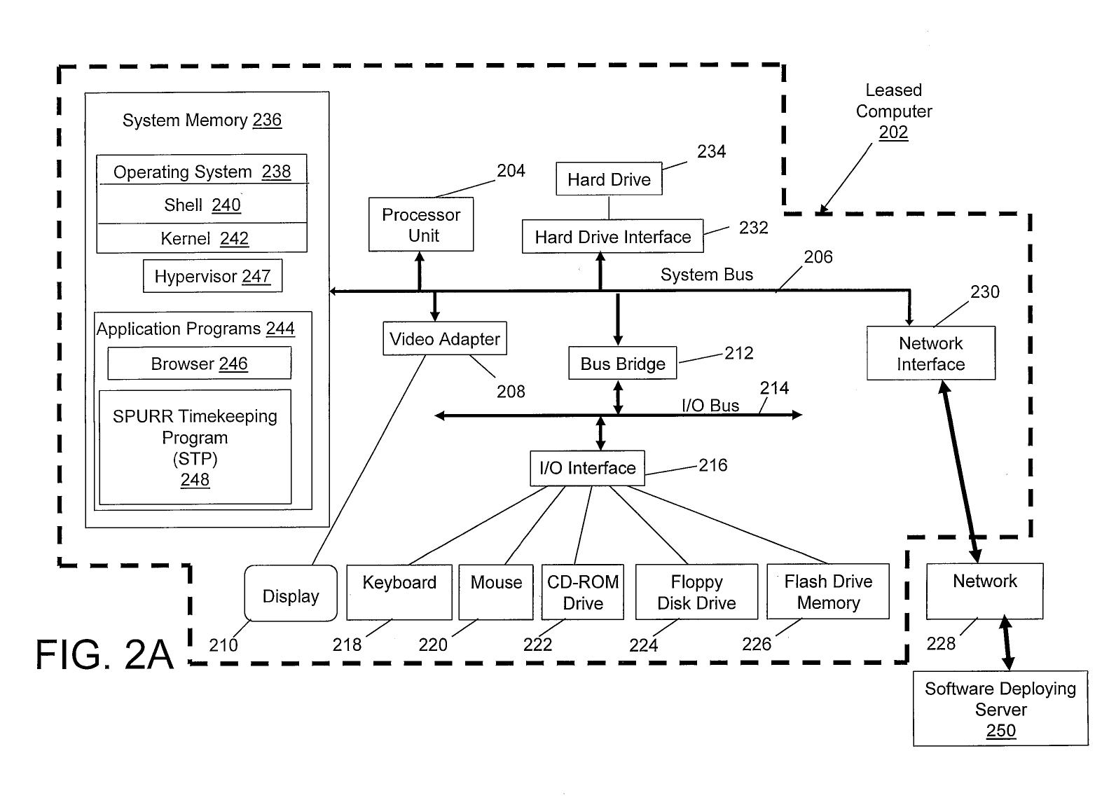

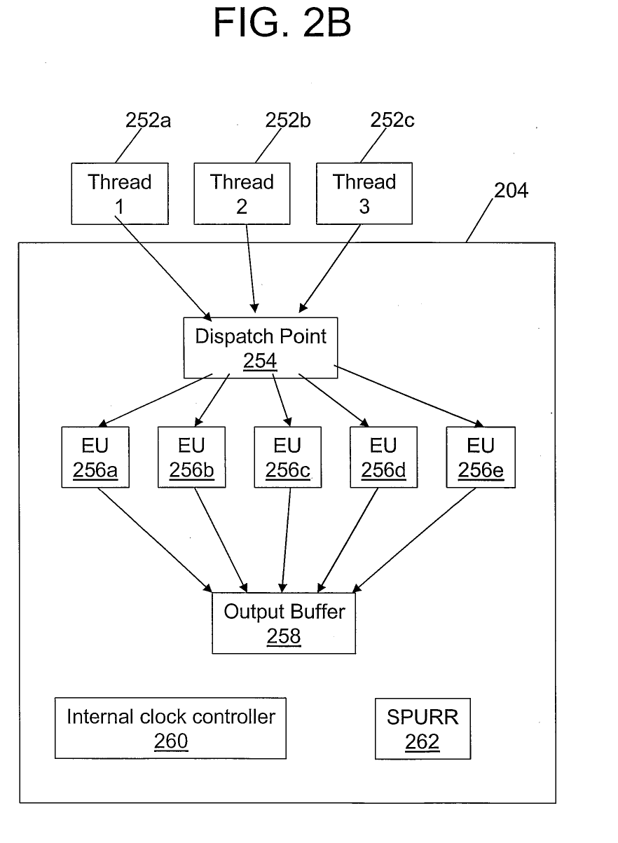

Since the values retrieved from the PURR do not depend on the current throughput rate of the machine, the PURR is no longer adequate for accurate accounting and charging. Thus, processors that support dynamic power management add an additional set of SPRs to allow the system software to provide accurate accounting. The new per-hardware-thread SPR is called the Scaled Processor Utilization of Resources Register or SPURR, depicted in FIG. 2B as SPURR 262. In a preferred embodiment, there is one SPURR for each hardware thread, and the SPURR is a 64-bit register. To allow hypervisors to virtualize it by saving and restoring it on partition switch, the SPURR is writeable in privileged state with hypervisor bit on (HV=1), readable in privileged state and inaccessible in problem state.

The SPURR is defined as follows where HWT_i is one of the hardware threads and tb is the value of the TimeBase register in TimeBase ticks.

(SPURRD)SPURR(HWT_{—}i)=(HWT_iinstructions_dispatched_per_{—}tb_tick/(ΣHWT_{—}j_instructions_dispatched_per_{—}tb_tick))*(f_effective/f_nominal)*(1−throttling_factor)*(1−IPC_limiting_factor)*(tb)

where

f_effective=the current frequency of the processor cores

f_nominal=the nominal frequency of the processor cores

(f_effective/f_nominal)=the frequency scaling.

The throttling factor is the result of the use of the run-and-hold throttling mechanism described above. If there are run_cycles of run and hold_cycles of hold in the window, then

(TFD)throttling_factor=(hold_cycles)/(run_cycles+hold_cycles).

The IPC-limiting factor is due to the clipping of the maximum IPC of the thread to the core limit as described above. Let dead_cycles be the number of cycles that the IPC-limiting mechanism kills, and let live_cycles be the number of surviving cycles. Then the IPC_limiting_factor is defined as follows.

(IPCLFD)IPC_limiting factor=(dead_cycles)/(dead_cycles+live_cycles)

The typical implementation just increments the cycle count that accumulates to track the hardware thread's ticks faster or slower depending on the state of the core. The SPURR assigns unusable cycles in which no thread can dispatch instructions in the same manner as the PURR.

There is a consistency criterion that applies to the SPURR. If f_effective=f_nominal and there is no throttling of either form, then PURR(HWT)=SPURR(HWT) for all hardware threads. The SPURR is monotonically non-decreasing, but the other PURR invariants need not hold.

### Processor Utilization Calculations

The definition of processor utilization, which is the only type that the hypervisor and the OSes have in view and which is alluded to in the previous section, under this invention continues to be based on the PURR and does not change. In the following, assume that the SWT is the software thread and the HWT is whatever hardware thread it gets when it runs. The following defines the utilization in a dispatch interval.

(UD)Utilization(SWT)=(tb_ticks_not_in_idle/total_tb_ticks)*(PURR(HWT)_at_end_of_interval−PURR(HWT)_at_start_of_interval)

This is utilization relative to the capacity provided. Of course, if the capacity is less due to throttling or slewing, the utilization goes up, but that matches both intuition and the semantics of previous implementations. Similarly, if the capacity is more, the utilization goes down.

### Accounting

Accurate accounting schemes use the SPURR since not all cycles and all TimeBase ticks always have the same capacity to get work done, and, thus, users should not be charged the same for them. The charge for a software thread SWT over a dispatch interval, with SWT assigned to hardware thread HWT, is defined as follows.

(AC)AccountingCharge=(SPURR(HWT)_at_end_of_interval−SPURR(HWT)_at_start_of_interval)−SPURR(idle)_over_the_interval

The system software may further adjust the accounting charge to eliminate the time that is spent in interrupt handlers.

One of the most important ways that active power management controls system power and temperature is by changing the effective speed of the processors in the machine. However, current implementations of accurate accounting and their accompanying hardware support do not anticipate such changes. The invention disclosed here adds a new set of processor registers, one register per hardware thread, which all systems software running on power-managed processors can read to support accurate accounting. It also describes how these registers are used to support accurate accounting.

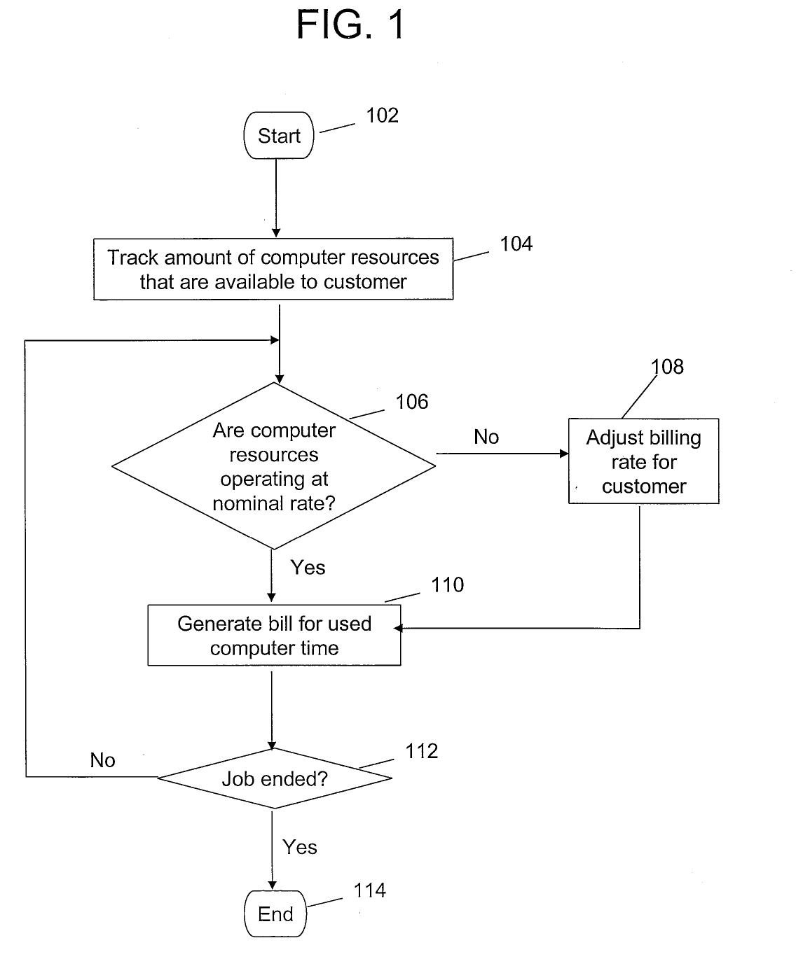

With reference now to the figures, and in particular to FIG. 1, a flow-chart of exemplary steps taken by the present invention is presented. After initiator block 102, which may be in response to a SPURR being brought on-line, the amount of computer resources that are available to a customer are tracked (block 104). Note that, in the preferred embodiment, it is the amount of computer resources that are available, rather than the computer resources that are actually used, that are tracked. Thus, if a client is allocated certain computer resources, but does not use them due to inefficient client generated software or poor planning, the client is nonetheless charged for the available computer resources for a specified period of time. Note that this is consistent with the previous charge model, where the customer was charged solely based on number of compute cycles committed to their workload. The resources may be execution units in a processor core, available memory, or any other resources (hardware and software) available in a lessor's SMT computer.

If the available computer resources are operating (query block 106) at a nominal rate (as defined below), then a bill is generated at a charge that is appropriate for the nominal rate (block 110). That is, if the SMT computer is operating at normal speed, then the customer (lessee) pays a normal fee for the amount of time that resources are available to him. However, if the computer resources are NOT operating at the nominal rate, then a multiplier is created (block 108) that adjusts the customer's bill accordingly. For example, if the SMT computer has throttled up or down the number of instructions that can be dispatched during some pre-determined period of time, and/or if the SMT computer has adjusted its internal clock cycle (e.g., in response to the core overheating), then the bill is adjusted up or down to reflect the condition that the customer has more or less (effective) computing resources available during that pre-determined period of time. As soon as the job ends (query block 112), the process ends (terminator block 114).

With reference now to FIG. 2A, there is depicted a block diagram of an exemplary leased computer 202, in which the present invention may be utilized. Leased computer 202 includes a processor unit 204 that is coupled to a system bus 206. A video adapter 208, which drives/supports a display 210, is also coupled to system bus 206. System bus 206 is coupled via a bus bridge 212 to an Input/Output (I/O) bus 214. An I/O interface 216 is coupled to I/O bus 214. I/O interface 216 affords communication with various I/O devices, including a keyboard 218, a mouse 220, a Compact Disk-Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports.

Leased computer 202 is able to communicate with a software deploying server 250 via a network 228 using a network interface 230, which is coupled to system bus 206. Network 228 may be an external network such as the Internet, or an internal network such as an Ethernet or a Virtual Private Network (VPN). Using network 228, leased computer 202 is able to use the present invention to access software deploying server 250.

A hard drive interface 232 is also coupled to system bus 206. Hard drive interface 232 interfaces with a hard drive 234. In a preferred embodiment, hard drive 234 populates a system memory 236, which is also coupled to system bus 206. System memory is defined as a lowest level of volatile memory in leased computer 202. This volatile memory may include additional higher levels of volatile memory (not shown), including but not limited to cache memory, registers, and buffers. Data that populates system memory 236 includes leased computer 202's operating system (OS) 238 and application programs 244. Also located within system memory 236 is a hypervisor 247, whose function is described above and below.

OS 238 includes a shell 240, for providing transparent user access to resources such as application programs 244. Generally, shell 240 is a program that provides an interpreter and an interface between the user and the operating system. More specifically, shell 240 executes commands that are entered into a command line user interface or from a file. Thus, shell 240 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. Note that while shell 240 is a text-based, line-oriented user interface, the present invention will equally well support other user interface modes, such as graphical, voice, gestural, etc.

As depicted, OS 238 also includes kernel 242, which includes lower levels of functionality for OS 238, including providing essential services required by other parts of OS 238 and application programs 244, including memory management, process and task management, disk management, and mouse and keyboard management.

Application programs 244 include a browser 246. Browser 246 includes program modules and instructions enabling a World Wide Web (WWW) client (i.e., leased computer 202) to send and receive network messages to the Internet using HyperText Transfer Protocol (HTTP) messaging, thus enabling communication with software deploying server 250.

Application programs 244 in leased computer 202's system memory also include an SPURR Timekeeping Program (STP) 248, which includes code for implementing the processes described in FIG. 1. In one embodiment, leased computer 202 is able to download STP 248 from software deploying server 250, which may utilize a similar architecture as shown in FIG. 2A for leased computer 202.

The hardware elements depicted in leased computer 202 are not intended to be exhaustive, but rather are representative to highlight essential components required by the present invention. For instance, leased computer 202 may include alternate memory storage devices such as magnetic cassettes, Digital Versatile Disks (DVDs), Bernoulli cartridges, and the like. These and other variations are intended to be within the spirit and scope of the present invention.

As described above, in one embodiment, the processes described by the present invention, including the functions of STP 248, are performed by software deploying server 250. Alternatively, STP 248 and the method described herein, and in particular as shown and described in FIG. 1, can be deployed as a process software from software deploying server 250 to leased computer 202. Still more particularly, process software for the method so described may be deployed to software deploying server 250 by another software deploying server (not shown). Alternatively, STP 248 may be part of the kernel 242.

Reference is now made to FIG. 2B, which depicts additional high-level detail of processor unit 204. Since processor unit 204 is part of a Simultaneous Multithreading (SMT) computer (leased computer 202), multiple threads (shown in illustrative manner as threads 252a-c) can be simultaneously (pipelined) handled by a dispatch point 254, which dispatched the multiple threads 252 in parallel fashion to various execution units (shown as EUs 256a-e) in the processor unit 204. These execution units then output results of their operations to an output buffer 258. However, in the event that the processor unit 204 needs to be throttled down (e.g., if it is overheating) or throttled up (e.g., a bus, not shown, is able to increase the amount of data traffic to some component of processor unit 204), then dispatch point 254 may start dispatching threads faster, and/or an internal clock controller 260 may increase the internal clock cycle rate for the processor unit 204. All of this activity is recorded in the Scaled Processor Utilization of Resources Register (SPURR) 262, whose function is described in detail above.

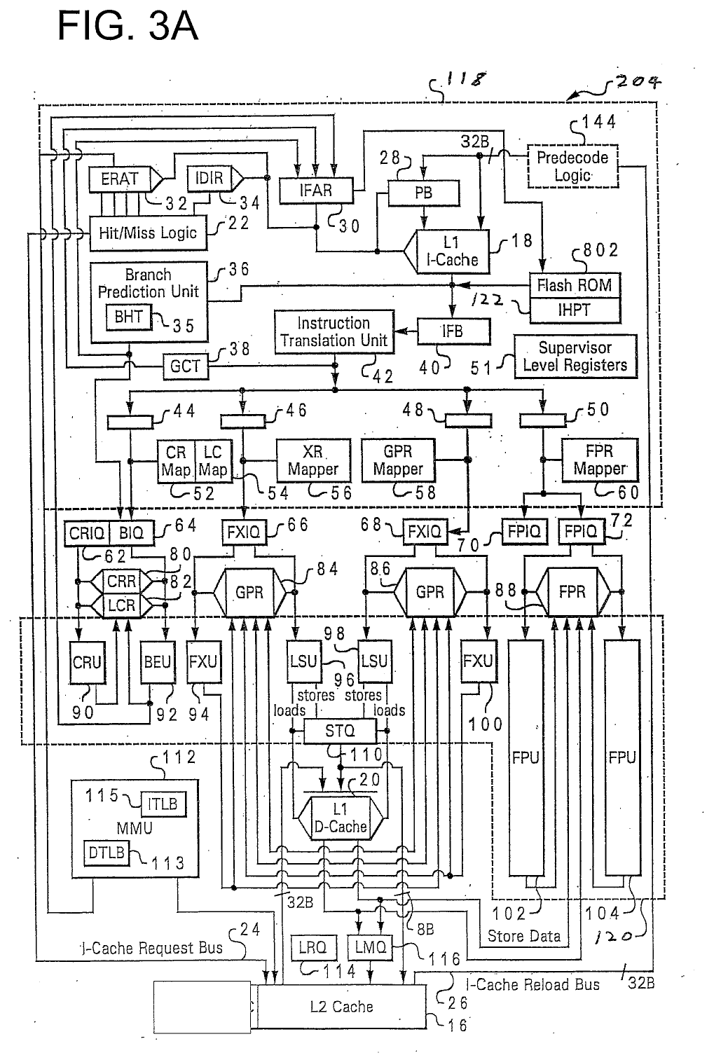

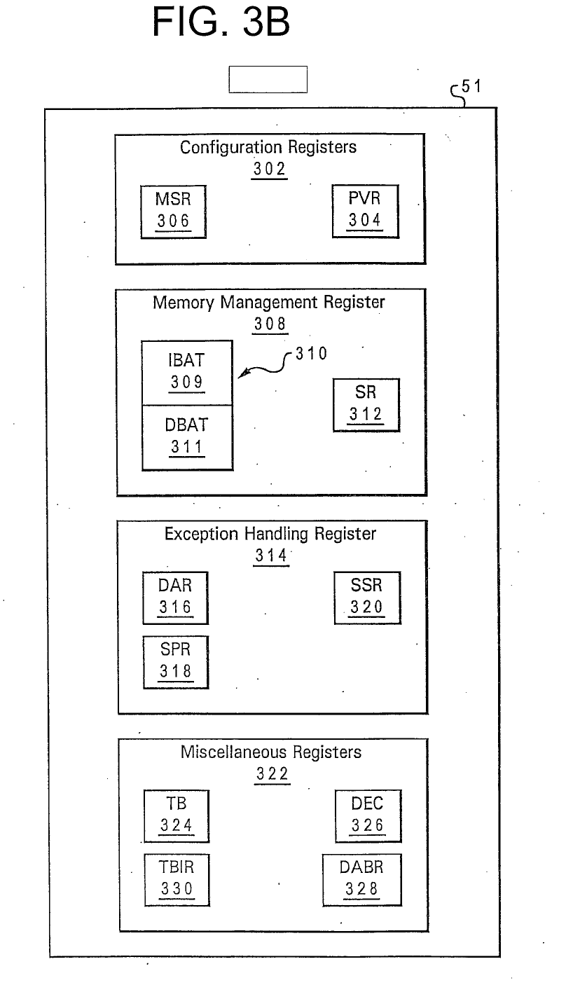

With reference now to FIG. 3A, additional detail for the core of processing unit 204 is shown. Such detail is particularly relevant in the scenario described above, in which any of the components shown and described in FIGS. 3A-B may be throttled, thus resulting in a non-nominal performance that leads to a billing adjustment, as described herein.

Processing unit 204 includes an on-chip multi-level cache hierarchy including a unified level two (L2) cache 16 and bifurcated level one (L1) instruction (I) and data (D) caches 18 and 20, respectively. As is well-known to those skilled in the art, caches 16, 18 and 20 provide low latency access to cache lines corresponding to memory locations in system memories 236 (shown in FIG. 2A).

Instructions are fetched for processing from L1 I-cache 18 in response to the effective address (EA) residing in instruction fetch address register (IFAR) 30. During each cycle, a new instruction fetch address may be loaded into IFAR 30 from one of three sources: branch prediction unit (BPU) 36, which provides speculative target path and sequential addresses resulting from the prediction of conditional branch instructions, global completion table (GCT) 38, which provides flush and interrupt addresses, and branch execution unit (BEU) 92, which provides non-speculative addresses resulting from the resolution of predicted conditional branch instructions. Associated with BPU 36 is a branch history table (BHT) 35, in which are recorded the resolutions of conditional branch instructions to aid in the prediction of future branch instructions.

An effective address (EA), such as the instruction fetch address within IFAR 30, is the address of data or an instruction generated by a processor. The EA specifies a segment register and offset information within the segment. To access data (including instructions) in memory, the EA is converted to a real address (RA), through one or more levels of translation, associated with the physical location where the data or instructions are stored.

Within processing unit 204, effective-to-real address translation is performed by memory management units (MMUs) and associated address translation facilities. Preferably, a separate MMU is provided for instruction accesses and data accesses. In FIG. 3A, a single MMU 112 is illustrated, for purposes of clarity, showing connections only to instruction sequencing unit (ISU) 118. However, it is understood by those skilled in the art that MMU 112 also preferably includes connections (not shown) to load/store units (LSUs) 96 and 98 and other components necessary for managing memory accesses. MMU 112 includes data translation lookaside buffer (DTLB) 113 and instruction translation lookaside buffer (ITLB) 115. Each TLB contains recently referenced page table entries, which are accessed to translate EAs to RAs for data (DTLB 113) or instructions (ITLB 115). Recently referenced EA-to-RA translations from ITLB 115 are cached in EOP effective-to-real address table (ERAT) 32.

If hit/miss logic 22 determines, after translation of the EA contained in IFAR 30 by ERAT 32 and lookup of the real address (RA) in I-cache directory 34, that the cache line of instructions corresponding to the EA in IFAR 30 does not reside in L1 I-cache 18, then hit/miss logic 22 provides the RA to L2 cache 16 as a request address via I-cache request bus 24. Such request addresses may also be generated by prefetch logic within L2 cache 16 based upon recent access patterns. In response to a request address, L2 cache 16 outputs a cache line of instructions, which are loaded into prefetch buffer (PB) 28 and L1 I-cache 18 via I-cache reload bus 26, possibly after passing through optional predecode logic 144.

Once the cache line specified by the EA in IFAR 30 resides in L1 cache 18, L1 I-cache 18 outputs the cache line to both branch prediction unit (BPU) 36 and to instruction fetch buffer (IFB) 40. BPU 36 scans the cache line of instructions for branch instructions and predicts the outcome of conditional branch instructions, if any. Following a branch prediction, BPU 36 furnishes a speculative instruction fetch address to IFAR 30, as discussed above, and passes the prediction to branch instruction queue 64 so that the accuracy of the prediction can be determined when the conditional branch instruction is subsequently resolved by branch execution unit 92.

IFB 40 temporarily buffers the cache line of instructions received from L1 I-cache 18 until the cache line of instructions can be translated by instruction translation unit (ITU) 42. In the illustrated embodiment of processing unit 204, ITU 42 translates instructions from user instruction set architecture (UISA) instructions into a possibly different number of internal ISA (IISA) instructions that are directly executable by the execution units of processing unit 204. Such translation may be performed, for example, by reference to microcode stored in a read-only memory (ROM) template. In at least some embodiments, the UISA-to-IISA translation results in a different number of IISA instructions than UISA instructions and/or IISA instructions of different lengths than corresponding UISA instructions. The resultant IISA instructions are then assigned by global completion table 38 to an instruction group, the members of which are permitted to be dispatched and executed out-of-order with respect to one another. Global completion table 38 tracks each instruction group for which execution has yet to be completed by at least one associated EA, which is preferably the EA of the oldest instruction in the instruction group.

Following UISA-to-IISA instruction translation, instructions are dispatched to one of latches 44, 46, 48 and 50, possibly out-of-order, based upon instruction type. That is, branch instructions and other condition register (CR) modifying instructions are dispatched to latch 44, fixed-point and load-store instructions are dispatched to either of latches 46 and 48, and floating-point instructions are dispatched to latch 50. Each instruction requiring a rename register for temporarily storing execution results is then assigned one or more rename registers by the appropriate one of CR mapper 52, link and count (LC) register mapper 54, exception register (XER) mapper 56, general-purpose register (GPR) mapper 58, and floating-point register (FPR) mapper 60.

The dispatched instructions are then temporarily placed in an appropriate one of CR issue queue (CRIQ) 62, branch issue queue (BIQ) 64, fixed-point issue queues (FXIQs) 66 and 68, and floating-point issue queues (FPIQs) 70 and 72. From issue queues 62, 64, 66, 68, 70 and 72, instructions can be issued opportunistically to the execution units of processing unit 10 for execution as long as data dependencies and antidependencies are observed. The instructions, however, are maintained in issue queues 62-72 until execution of the instructions is complete and the result data, if any, are written back, in case any of the instructions needs to be reissued.

As illustrated, the execution units of processing unit 204 include a CR unit (CRU) 90 for executing CR-modifying instructions, a branch execution unit (BEU) 92 for executing branch instructions, two fixed-point units (FXUs) 94 and 100 for executing fixed-point instructions, two load-store units (LSUs) 96 and 98 for executing load and store instructions, and two floating-point units (FPUs) 102 and 104 for executing floating-point instructions. Each of execution units 90-104 is preferably implemented as an execution pipeline having a number of pipeline stages.

During execution within one of execution units 90-104, an instruction receives operands, if any, from one or more architected and/or rename registers within a register file coupled to the execution unit. When executing CR-modifying or CR-dependent instructions, CRU 90 and BEU 92 access the CR register file 80, which in a preferred embodiment contains a CR and a number of CR rename registers that each comprise a number of distinct fields formed of one or more bits. Among these fields are LT, GT, and EQ fields that respectively indicate if a value (typically the result or operand of an instruction) is less than zero, greater than zero, or equal to zero. Link and count register (LCR) register file 82 contains a count register (CTR), a link register (LR) and rename registers of each, by which BEU 92 may also resolve conditional branches to obtain a path address. General-purpose register files (GPRs) 84 and 86, which are synchronized, duplicate register files, store fixed-point and integer values accessed and produced by FXUs 94 and 100 and LSUs 96 and 98. Floating-point register file (FPR) 88, which like GPRs 84 and 86 may also be implemented as duplicate sets of synchronized registers, contains floating-point values that result from the execution of floating-point instructions by FPUs 102 and 104 and floating-point load instructions by LSUs 96 and 98.

After an execution unit finishes execution of an instruction, the execution notifies GCT 38, which schedules completion of instructions in program order. To complete an instruction executed by one of CRU 90, FXUs 94 and 100 or FPUs 102 and 104, GCT 38 signals the execution unit, which writes back the result data, if any, from the assigned rename register(s) to one or more architected registers within the appropriate register file. The instruction is then removed from the issue queue, and once all instructions within its instruction group have completed, is removed from GCT 38. Other types of instructions, however, are completed differently.

When BEU 92 resolves a conditional branch instruction and determines the path address of the execution path that should be taken, the path address is compared against the speculative path address predicted by BPU 36. If the path addresses match, no further processing is required. If, however, the calculated path address does not match the predicted path address, BEU 92 supplies the correct path address to IFAR 30. In either event, the branch instruction can then be removed from BIQ 64, and when all other instructions within the same instruction group have completed, from GCT 38.

Following execution of a load instruction, the effective address computed by executing the load instruction is translated to a real address by a data ERAT (not illustrated) and then provided to L1 D-cache 20 as a request address. At this point, the load instruction is removed from FXIQ 66 or 68 and placed in load reorder queue (LRQ) 114 until the indicated load is performed. If the request address misses in L1 D-cache 20, the request address is placed in load miss queue (LMQ) 116, from which the requested data is retrieved from L2 cache 16, and failing that, from another processing unit 202 or from system memory 236 (shown in FIG. 2A). LRQ 114 snoops exclusive access requests (e.g., read-with-intent-to-modify), flushes or kills on an interconnect fabric against loads in flight, and if a hit occurs, cancels and reissues the load instruction. Store instructions are similarly completed utilizing a store queue (STQ) 110 into which effective addresses for stores are loaded following execution of the store instructions. From STQ 110, data can be stored into either or both of L1 D-cache 20 and L2 cache 16.

### Processor States

The state of a processor includes stored data, instructions and hardware states at a particular time, and are herein defined as either being “hard” or “soft.” The “hard” state is defined as the information within a processor that is architecturally required for a processor to execute a process from its present point in the process. The “soft” state, by contrast, is defined as information within a processor that would improve efficiency of execution of a process, but is not required to achieve an architecturally correct result. In processing unit 204 of FIG. 3A, the hard state includes the contents of user-level registers, such as CRR 80, LCR 82, GPRs 84 and 86, FPR 88, as well as supervisor level registers 51. The soft state of processing unit 204 includes both “performance-critical” information, such as the contents of L-1 I-cache 18, L-1 D-cache 20, address translation information such as DTLB 113 and ITLB 115, and less critical information, such as BHT 35 and all or part of the content of L2 cache 16.

The hard architected state is stored to system memory through the load/store unit of the processor core, which blocks execution of the interrupt handler or another process for a number of processor clock cycles. Alternatively, upon receipt of an interrupt, processing unit 204 suspends execution of a currently executing process, such that the hard architected state stored in hard state registers is then copied directly to shadow register. The shadow copy of the hard architected state, which is preferably non-executable when viewed by the processing unit 204, is then stored to system memory 236. The shadow copy of the hard architected state is preferably stored in a special memory area within system memory 236 that is reserved for hard architected states.

Saving soft states differs from saving hard states. When an interrupt handler is executed by a conventional processor, the soft state of the interrupted process is typically polluted. That is, execution of the interrupt handler software populates the processor's caches, address translation facilities, and history tables with data (including instructions) that are used by the interrupt handler. Thus, when the interrupted process resumes after the interrupt is handled, the process will experience increased instruction and data cache misses, increased translation misses, and increased branch mispredictions. Such misses and mispredictions severely degrade process performance until the information related to interrupt handling is purged from the processor and the caches and other components storing the process' soft state are repopulated with information relating to the process. Therefore, at least a portion of a process' soft state is saved and restored in order to reduce the performance penalty associated with interrupt handling. For example, the entire contents of L1 I-cache 18 and L1 D-cache 20 may be saved to a dedicated region of system memory 236. Likewise, contents of BHT 35, ITLB 115 and DTLB 113, ERAT 32, and L2 cache 16 may be saved to system memory 236.

Because L2 cache 16 may be quite large (e.g., several megabytes in size), storing all of L2 cache 16 may be prohibitive in terms of both its footprint in system memory and the time/bandwidth required to transfer the data. Therefore, in a preferred embodiment, only a subset (e.g., two) of the most recently used (MRU) sets are saved within each congruence class.

Thus, soft states may be streamed out while the interrupt handler routines (or next process) are being executed. This asynchronous operation (independent of execution of the interrupt handlers) may result in an intermingling of soft states (those of the interrupted process and those of the interrupt handler). Nonetheless, such intermingling of data is acceptable because precise preservation of the soft state is not required for architected correctness and because improved performance is achieved due to the shorter delay in executing the interrupt handler.

Management of both soft and hard architected states may be managed by a hypervisor, which is accessible by multiple processors within any partition. That is, Processor A and Processor B may initially be configured by the hypervisor to function as an SMP within Partition X, while Processor C and Processor D are configured as an SMP within Partition Y. While executing, processors A-D may be interrupted, causing each of processors A-D to store a respective one of hard states A-D and soft states A-D to memory in the manner discussed above. Any processor can access any of hard or soft states A-D to resume the associated interrupted process. For example, in addition to hard and soft states C and D, which were created within its partition, Processor D can also access hard and soft states A and B. Thus, any process state can be accessed by any partition or processor(s). Consequently, the hypervisor has great freedom and flexibility in load balancing between partitions.

### Registers

In the description above, register files of processing unit 204 such as GPR 86, FPR 88, CRR 80 and LCR 82 are generally defined as “user-level registers,” in that these registers can be accessed by all software with either user or supervisor privileges. Supervisor level registers 51 include those registers that are used typically by an operating system, typically in the operating system kernel, for such operations as memory management, configuration and exception handling. As such, access to supervisor level registers 51 is generally restricted to only a few processes with sufficient access permission (i.e., supervisor level processes).

As depicted in FIG. 3B, supervisor level registers 51 generally include configuration registers 302, memory management registers 308, exception handling registers 314, and miscellaneous registers 322, which are described in more detail below.

Configuration registers 302 include a machine state register (MSR) 306 and a processor version register (PVR) 304. MSR 306 defines the state of the processor. That is, MSR 306 identifies where instruction execution should resume after an instruction interrupt (exception) is handled. PVR 304 identifies the specific type (version) of processing unit 200.

Memory management registers 308 include block-address translation (BAT) registers 310. BAT registers 310 are software-controlled arrays that store available block-address translations on-chip. Preferably, there are separate instruction and data BAT registers, shown as IBAT 309 and DBAT 311. Memory management registers also include segment registers (SR) 312, which are used to translate EAs to virtual addresses (VAs) when BAT translation fails.

Exception handling registers 314 include a data address register (DAR) 316, special purpose registers (SPRs) 318, and machine status save/restore (SSR) registers 320. The DAR 316 contains the effective address generated by a memory access instruction if the access causes an exception, such as an alignment exception. SPRs are used for special purposes defined by the operating system, for example, to identify an area of memory reserved for use by a first-level exception handler (FLIH). This memory area is preferably unique for each processor in the system. An SPR 318 may be used as a scratch register by the FLIH to save the content of a general purpose register (GPR), which can be loaded from SPR 318 and used as a base register to save other GPRs to memory. SSR registers 320 save machine status on exceptions (interrupts) and restore machine status when a return from interrupt instruction is executed.

Miscellaneous registers 322 include a time base (TB) register 324 for maintaining the time of day, a decrementer register (DEC) 326 for decrementing counting, and a data address breakpoint register (DABR) 328 to cause a breakpoint to occur if a specified data address is encountered. Further, miscellaneous registers 322 include a time based interrupt register (TBIR) 330 to initiate an interrupt after a pre-determined period of time. Such time based interrupts may be used with periodic maintenance routines to be run on processing unit 200.

### SLIH/FLIH Flash ROM

First Level Interrupt Handlers (FLIHs) and Second Level Interrupt Handlers (SLIHs) may also be stored in system memory, and populate the cache memory hierarchy when called. Normally, when an interrupt occurs in processing unit 204, a FLIH is called, which then calls a SLIH, which completes the handling of the interrupt. Which SLIH is called and how that SLIH executes varies, and is dependent on a variety of factors including parameters passed, conditions states, etc. Because program behavior can be repetitive, it is frequently the case that an interrupt will occur multiple times, resulting in the execution of the same FLIH and SLIH. Consequently, the present invention recognizes that interrupt handling for subsequent occurrences of an interrupt may be accelerated by predicting that the control graph of the interrupt handling process will be repeated and by speculatively executing portions of the SLIH without first executing the FLIH. To facilitate interrupt handling prediction, processing unit 204 is equipped with an Interrupt Handler Prediction Table (IHPT) 122. IHPT 122 contains a list of the base addresses (interrupt vectors) of multiple FLIHs. In association with each FLIH address, IHPT 122 stores a respective set of one or more SLIH addresses that have previously been called by the associated FLIH. When IHPT 122 is accessed with the base address for a specific FLIH, a prediction logic selects a SLIH address associated with the specified FLIH address in IHPT 122 as the address of the SLIH that will likely be called by the specified FLIH. Note that while the predicted SLIH address illustrated may be the base address of the SLIH, the address may also be an address of an instruction within the SLIH subsequent to the starting point (e.g., at point B).

Prediction logic uses an algorithm that predicts which SLIH will be called by the specified FLIH. In a preferred embodiment, this algorithm picks a SLIH, associated with the specified FLIH, which has been used most recently. In another preferred embodiment, this algorithm picks a SLIH, associated with the specified FLIH, which has historically been called most frequently. In either described preferred embodiment, the algorithm may be run upon a request for the predicted SLIH, or the predicted SLIH may be continuously updated and stored in IHPT 122.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Note further that, as described above, instructions used in each embodiment of a computer-usable medium may be deployed from a service provider to a user via a software deploying server. This deployment may be made in an “on-demand” basis as described herein.

The present invention thus provides for a method, system, and computer-usable medium that afford an equitably charging of a customer for computer usage time. In a preferred embodiment, the method includes the steps of: tracking an amount of computer resources in a Simultaneous Multithreading (SMT) computer that are available to a customer for a specified period of time; determining if the computer resources in the SMT computer are operating at a nominal rate; and in response to determining that the computer resources are operating at a non-nominal rate, adjusting a billing charge to the customer, wherein the billing charge reflects that the customer has available computer resources, in the SMT computer, that are not operating at the nominal rate during the specified period of time. The computer resources may be operating at the non-nominal rate due to a throttling of pipelined instructions in the SMT computer, thereby resulting in a non-nominal dispatch rate of instructions in the SMT computer. Alternatively, the computer resources may be operating at the non-nominal rate due to a change in a frequency of an internal clock of the SMT computer, wherein the frequency of the internal clock of the SMT computer is decreased in response to a processor core overheating. In another embodiment, the computer resources are operating at the non-nominal rate due to a non-nominal fetch rate of instructions in the SMT computer, while in yet another embodiment the computer resources are operating at the non-nominal rate due to a non-nominal instruction dispatch rate for instructions in the SMT computer. Furthermore, the non-nominal rate may be further due to a non-nominal frequency of an internal clock of the SMT computer, such that the billing charge is calculated by multiplying the reduced dispatch rate of instructions in the SMT computer by the non-nominal frequency of the internal clock to create a billing correction factor. Note that the present invention applies equally well when the processor is clocked at a value greater than its nominal rate. In that case, there are more processor cycles per timebase tick than at nominal, and the processor does more work per timebase tick.

For purposes of claim construction, the term “non-nominal” is defined as a rate that is different from a normal rate (“nominal rate”) in the Simultaneous Multithreading (SMT) computer that are available to a customer for a specified period of time. For example, the term “a non-nominal dispatch rate of instructions” is defined as a rate of dispatching instructions by a dispatch point (e.g., 254 in FIG. 2B) in the SMT computer that is either higher or lower than the normal rate at which instructions are dispatched. The term “change in a frequency of an internal clock of the SMT computer” is defined as the internal clock either being faster or slower than the frequency found during normal operations of the SMT computer. The term “normal operations” is understood to mean operations during which time operations are not throttled down (such as during overheating conditions) or throttled up (due to an unusual amount of available computer resources such as execution units in a processor core). The term “non-nominal fetch rate of instructions in the SMT computer” is defined as a rate in which a processor core fetches new instructions as a rate that are higher or lower than the average fetch rate for the SMT computer.

While the present invention has been particularly shown and described with reference to a preferred embodiment, it will be understood by those skilled in the art that various changes in form and detail may be made therein without departing from the spirit and scope of the invention. For example, the present invention is equally applicable to a machine that does not support SMT. Although the processors of such a machine will not have a PURR-like structure as described above, there is still a need to scale the time values used for accounting if the processors are subject to throttling or frequency changes. The same scaling mechanism works, and all of the same features apply with the only difference being that wherever the PURR is used on an SMT, the timebase is used on a machine without it.

Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

1. A method of equitably charging a customer for computer usage time, the method comprising:
tracking an amount of computer resources in a computer that are available to a customer for a specified period of time;
determining if the computer resources in the computer are operating at a nominal rate; and
in response to determining that the computer resources are operating at a non-nominal rate, adjusting a billing charge to the customer, wherein the billing charge reflects that the customer has available computer resources, in the computer, that are not operating at the nominal rate during the specified period of time.

2. The method of claim 1, wherein the computer resources are operating at the non-nominal rate due to a throttling of pipelined instructions in the computer, thereby resulting in a non-nominal dispatch rate of instructions in the computer.

3. The method of claim 1, wherein the computer resources are operating at the non-nominal rate due to a change in a frequency of an internal clock of the computer.

4. The method of claim 3, wherein the frequency of the internal clock of the computer is decreased in response to a processor core overheating.

5. The method of claim 1, wherein the computer resources are operating at the non-nominal rate due to a non-nominal fetch rate of instructions in the computer.

6. The method of claim 1, wherein the computer resources are operating at the non-nominal rate due to a non-nominal instruction dispatch rate for instructions in the computer.

7. The method of claim 2, wherein the non-nominal rate is farther due to a non-nominal frequency of an internal clock of the computer, and wherein the billing charge is calculated by multiplying the reduced dispatch rate of instructions in the computer by the non-nominal frequency of the internal clock to create a billing correction factor.

8. The method of claim 1, wherein the computer is a Simultaneous Multithreading (SMT) computer.

9. A system comprising:
a processor;
a data bus coupled to the processor;
a memory coupled to the data bus; and
a computer-usable medium embodying computer program code, the computer program code comprising instructions executable by the processor and configured for:
tracking an amount of computer resources in a Simultaneous Multithreading (SMT) computer that are available to a customer for a specified period of time;
determining if the computer resources in the SMT computer are operating at a nominal rate; and
in response to determining that the computer resources are operating at a non-nominal rate, adjusting a billing charge to the customer, wherein the billing charge reflects that the customer has available computer resources, in the SMT computer, that are not operating at the nominal rate during the specified period of time.

10. The system of claim 9, wherein the computer resources are operating at the non-nominal rate due to a throttling of pipelined instructions in the SMT computer, thereby resulting in a non-nominal dispatch rate of instructions in the SMT computer.

11. The system of claim 9, wherein the computer resources are operating at the non-nominal rate due to a change in a frequency of an internal clock of the SMT computer.

12. The system of claim 11, wherein the frequency of the internal clock of the SMT computer is decreased in response to a processor core overheating.

13. The system of claim 9, wherein the computer resources are operating at the non-nominal rate due to a non-nominal fetch rate of instructions in the SMT computer.

14. The system of claim 9, wherein the computer resources are operating at the non-nominal rate due to a non-nominal instruction dispatch rate for instructions in the SMT computer.

15. The system of claim 10, wherein the non-nominal rate is further due to a non-nominal frequency of an internal clock of the SMT computer, and wherein the billing charge is calculated by multiplying the reduced dispatch rate of instructions in the SMT computer by the non-nominal frequency of the internal clock to create a billing correction factor.

16. A computer-usable medium embodying computer program code, the computer program code comprising computer executable instructions configured for:
tracking an amount of computer resources in a Simultaneous Multithreading (SMT) computer that are available to a customer for a specified period of time;
determining if the computer resources in the SMT computer are operating at a nominal rate; and
in response to determining that the computer resources are operating at a non-nominal rate, adjusting a billing charge to the customer, wherein the billing charge reflects that the customer has available computer resources, in the SMT computer, that are not operating at the nominal rate during the specified period of time.

17. The computer-usable medium of claim 16, wherein the computer resources are operating at the non-nominal rate due to a throttling of pipelined instructions in the SMT computer, thereby resulting in a non-nominal dispatch rate of instructions in the SMT computer.

18. The computer-usable medium of claim 16, wherein the computer resources are operating at the non-nominal rate due to a change in a frequency of an internal clock of the SMT computer.

19. The computer-usable medium of claim 18, wherein the frequency of the internal clock of the SMT computer is decreased in response to a processor core overheating.

20. The computer-usable medium of claim 16, wherein the computer resources are operating at the non-nominal rate due to a non-nominal fetch rate of instructions in the SMT computer.
